(19) United States
(12) Patent Application Publication
(10) Pub. No.: US 2019/0093353 A1
(43) Pub. Date: Mar. 28, 2019

(54) PANEL FOR BATHROOM APPLICATIONS AND METHOD FOR FABRICATING THE SAME

(71) Applicant: AMERICAN BATH GROUP, LLC, Savannah, TN (US)

(72) Inventors: Rick STONECIPHER, Savannah, TN (US); Scott STONECIPHER, Savannah, TN (US); Will RICE, Savannah, TN (US); Jason BURDETTE, Savannah, TN (US)

(21) Appl. No.: 16/135,785

(22) Filed: Sep. 19, 2018

Related U.S. Application Data
(60) Provisional application No. 62/562,857, filed on Sep. 25, 2017.

(51) Int. Cl. E04C 2/22; E04C 2/30; E04B 2/00

(52) U.S. Cl. CPC E04C 2/22; B32B 15/09; E04C 2/44; E04C 2/30

(57) ABSTRACT

There is described a panel comprising: a backing layer having a back face and a front face opposite to the back face, the backing layer being made of polyester resin; an intermediary layer attached to the backing layer; and a surface layer attached to the intermediary layer, the surface layer being made of acrylic modified isophthalic gelcoat.

### CROSS-REFERENCE TO RELATED APPLICATIONS

This application claims the benefit of U.S. Application Ser. No. 62/562,857, filed on Sep. 25, 2017, which application is incorporated by reference herein.

### TECHNICAL FIELD

The present invention relates to the field of panels and methods for fabricating panels, and more particularly to panels for a shower or a bathtub and methods for fabricating panels for a shower or a bathtub

### BACKGROUND

Usual panels for shower or bathtubs are made of several layers of different layers. One of these layers is a reinforcement layer used to provide strength to the panel. The reinforcement layer is usually made of wood or surrogate. However, such materials are susceptible to moisture which can adversely impact the adhesion of the wood or surrogate to the adjacent layers. Furthermore, wood or surrogate may not be flexible enough to conform to the contour of a typical bathtub or shower.

Some prior art panels comprise a reinforcement layer made of Balsa. While it improves the flexibility of the panel with respect to other wood and surrogate, Balsa is still susceptible to moisture.

Therefore, there is a need for an improved panel for bathroom applications.

### SUMMARY

According to a first broad aspect, there is provided a panel comprising: a backing layer having a back face and a front face opposite to the back face, the backing layer being made of polyester resin; an intermediary layer attached to the backing layer; and a surface layer attached to the intermediary layer, the surface layer being made of acrylic modified isophthalic gelcoat.

In one embodiment, the backing layer is made of ArmorCore™.

In one embodiment, the surface layer is made of AcrylX™.

In one embodiment, the intermediary layer is made of fiber-reinforced polymer.

In one embodiment, the intermediary layer is made of at least one of a polymer, a polyester and a resin.

In one embodiment, the panel further comprises an additional layer attached to the back face of the backing layer.

In one embodiment, the additional layer is made of fiber-reinforced polymer.

In one embodiment, the additional layer is made of at least one of a polymer, a polyester and a resin.

In one embodiment, wherein a face of the additional layer opposite to the backing layer is adapted to abut a panel-receiving surface.

In one embodiment, the panel receiving surface is one of a wall, a floor and a ceiling.

In one embodiment, the panel is part of a shower.

In one embodiment, the panel is part of a bathtub.

According to another broad aspect, there is provided a method for manufacturing a panel, comprising: providing a panel mold having a base panel; applying a layer of acrylic modified isophthalic gelcoat on the base panel of the panel mold; applying an intermediary layer on the layer of acrylic modified isophthalic gelcoat; and applying a layer of polyester resin on the intermediary layer.

In one embodiment, the step of applying a layer of acrylic modified isophthalic gelcoat comprises applying a layer of AcrylX™ on the base panel of the panel mold.

In one embodiment, the step of applying a layer of acrylic modified isophthalic gelcoat comprises spraying the acrylic modified isophthalic gelcoat on the base panel of the panel mold.

In one embodiment, the step of spraying the layer of acrylic modified isophthalic gelcoat comprises spraying the AcrylX™ on the base panel of the panel mold.

In one embodiment, the step of applying an intermediary layer comprises applying an intermediary layer of at least one of a polymer, a fiber-reinforced polymer, a polyester and a resin.

In one embodiment, the step of applying an intermediary layer comprises spraying the intermediary layer.

In one embodiment, the method further comprises applying an additional layer on the layer of polyester resin.

In one embodiment, the step of applying an additional layer comprises applying the additional layer of at least one of a polymer, a fiber-reinforced polymer, a polyester and a resin.

In one embodiment, the step of applying an additional layer comprises spraying the additional layer.

In one embodiment, the step of applying a layer of polyester resin comprises applying a layer of ArmorCore™.

In one embodiment, the step of applying a layer of polyester resin comprises spraying the polyester resin on the intermediary layer.

### BRIEF DESCRIPTION OF THE DRAWINGS

Further features and advantages of the present invention will become apparent from the following detailed description, taken in combination with the appended drawings, in which:

FIG. 1 is a block diagram illustrating a panel for bathroom applications, in accordance with an embodiment; and

FIG. 2 is a flow chart illustrating a method for fabricating the panel of FIG. 1, in accordance with an embodiment.

It will be noted that throughout the appended drawings, like features are identified by like reference numerals.

### DETAILED DESCRIPTION

There is described a panel for a bathtub or a shower that comprises at least three layers of different materials. The panel may be part of a shower such as a shower wall, ceiling or base, a bathtub, a bathroom sink, etc. For example, the panel may be shaped so as to correspond to a bathtub.

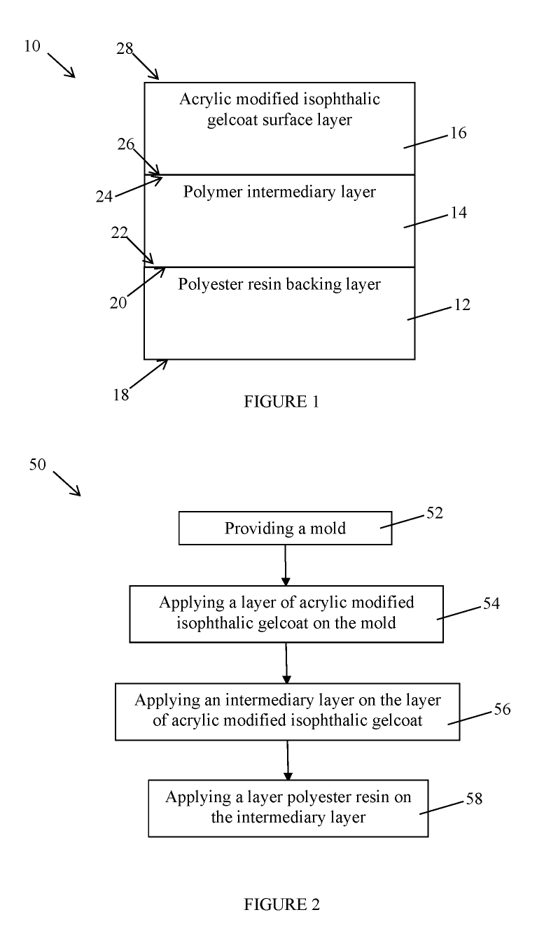

FIG. 1 schematically illustrates an exemplary panel 10 for bathroom applications. The panel 10 comprises at least three different layers 12, 14 and 16 deposited one on top of the other to form the panel.

The layer 12 is the back layer which acts as a support layer for the other layers 14 and 16 and provides the structural shape and strength for the panel 10. The layer 102 is the top of surface layer which will be apparent to a user. The intermediary layer 14 is sandwiched between the top layer 12 and the back layer 16. The intermediary layer 14 provides strength and structure for the panel 10.

The back layer 12 extends between a back face 18 and a top face 20 and the distance between the two faces 18 and 20 defines the thickness of the back layer 12. In one embodiment, the back layer 12 is adapted to be secured to a receiving surface such as a wall or a floor. The intermediary layer 14 extends between a bottom face 22 and a top face 24 and the distance between the two faces 22 and 24 defines the thickness of the intermediary layer 14. The bottom face 22 of the intermediary layer 14 is attached to the top face 20 of the back layer 12. The top or surface layer 16 extends between a bottom face 26 and a top face 28 and the distance between the two faces 26 and 28 defines the thickness of the top layer 16. The bottom face 26 of the top layer 16 is attached to the top face 24 of the intermediary layer 14. The top face 28 of the top layer 16 corresponds to the top surface of the panel 10, which is to be exposed to a user when the panel 10 is installed.

The back layer 12 is made of polyester resin. In one embodiment, the back layer is made of ArmorCore™.

The intermediary layer 14 is made of polymer. In one embodiment, the intermediary layer is made of fiber-reinforced polymer. The intermediary layer may also be made of polyester or fiberglass and/or resin.

It should be understood that the intermediary layer 14 may comprise more than one intermediary layers deposited one on top of the other between the layers 12 and 16. The different intermediary layers may be made of the same material or of different materials.

The top layer 16 is a layer made of acrylic modified isophthalic gelcoat. In one embodiment, the top layer 16 is made of AcrylX™.

In one embodiment, the panel 10 further comprises an additional layer attached to the back face 18 of the layer 12. In this case, the back face of the additional layer is adapted to abut a panel-receiving surface such as a wall, a floor or a ceiling of a bathroom.

The additional layer is made of polymer. In one embodiment, the additional layer is made of fiber-reinforced polymer. The additional layer may also be made of polyester or fiberglass and/or resin.

In one embodiment, the additional layer is made of the same material as that of the intermediary layer. In another embodiment, the additional and intermediary layers are made of different materials.

It should be understood that the additional layer may comprise more than one layer deposited one on top of the other. The different additional layers may be made of the same material or of different materials.

In one embodiment, the panel 10 is shaped and sized so as to correspond to at least a portion of a shower. For example, the panel 10 may be shaped and sized so as to correspond to a wall, a floor, a ceiling, or the like of a shower.

In another embodiment, the panel 10 is shaped and sized so as to correspond to a bath tub.

FIG. 2 illustrates one embodiment of a method 50 for fabricating the panel 10. The first step 52 of the method 50 consists in providing a mold having a desired shape and size to correspond to a bathroom application. For example, the mold may be sized and shaped so as to correspond to at least a portion of a shower such as a wall of a shower, a base of a shower, a ceiling of a shower, and/or the like. In another example, the mold may be shaped and sized so as to correspond to a bathtub.

At step 54, a layer of acrylic modified isophthalic gelcoat is applied on the mold. In one embodiment, a layer of AcrylX™ is applied on the mold at step 52.

Then, at step 56, a layer of polymer is applied on the layer of acrylic modified isophthalic gelcoat. In one embodiment, the polymer applied at step 56 on the layer of acrylic modified isophthalic gelcoat consists in fiber-reinforced polymer.

Finally, a layer of polyester resin is applied on the layer of polymer at step 58. In one embodiment, the layer of polyester resin consists in a layer of ArmorCore™. Once the different layers are dried, the panel is then formed and can be removed from the mold.

In one embodiment, the method 50 further comprises at least one curing step to dry the layers applied to the mold. For example, a first drying step may be performed after the application of the layer of acrylic modified isophthalic gelcoat on the mold. Once the layer of acrylic modified isophthalic gelcoat is dried, the layer of polymer is applied on the layer of acrylic modified isophthalic gelcoat. A second drying step is then performed in order to dry the layer of polymer. Once the layer of polymer is dried, the layer of polyester resin is applied on the layer of polymer. A final drying step is then performed in order to dry the layer of polyester resin.

It should be understood that any adequate method for applying a layer of material may be used. For example, a layer of material may be applied on the mold or another layer by spraying material. In another example, a roller or a brush may be used for applying a layer of material.

In one embodiment, the top layer 16 has a thickness comprised between about 0.3 mm and about 0.7 mm.

In one embodiment, once being applied to the mold at step 54, the layer of acrylic modified isophthalic gelcoat is cured at a temperature up to 140° F. for a period of time extending between about 15 minutes and about 35 minutes.

In one embodiment, the polyester resin layer 12 has a thickness of about 2.5 mm.

In one embodiment, once being applied on the intermediary layer at step 58, the layer of polyester resin is cured at a temperature up to 140° F. for a period of time extending between about 25 minutes and about 35 minutes.

In one embodiment, the panel 10 comprising a layer of ArmorCore™ is substantially impervious to moisture and freezing.

In an embodiment in which the panel 10 comprising a layer of ArmorCore™ the layer of ArmorCore™ chemically bonds with the intermediary layer and the additional layer, if any, which eliminates potential for separation.

In one embodiment, the resulting panel 10 is scored and pliable to conform to the contours of a bathtub or a shower.

The embodiments of the invention described above are intended to be exemplary only. The scope of the invention is therefore intended to be limited solely by the scope of the appended claims.

I/We claim:

1. A panel comprising:
a backing layer having a back face and a front face opposite to the back face, the backing layer being made of polyester resin;
an intermediary layer attached to the backing layer; and
a surface layer attached to the intermediary layer, the surface layer being made of acrylic modified isophthalic gelcoat.

2. The panel of claim 1, wherein the backing layer is made of ArmorCore™.

3. The panel of claim 1, wherein the surface layer is made of AcrylX™.

4. The panel of claim 1, wherein the intermediary layer is made of fiber-reinforced polymer.

5. The panel of claim 1, wherein the intermediary layer is made of at least one of a polymer, a polyester and a resin.

6. The panel of claim 1, further comprising an additional layer attached to the back face of the backing layer.

7. The panel of claim 6, wherein the additional layer is made of fiber-reinforced polymer.

8. The panel of claim 6, wherein the additional layer is made of at least one of a polymer, a polyester and a resin.

9. The panel of claim 6, wherein a face of the additional layer opposite to the backing layer is adapted to abut a panel-receiving surface.

10. The panel of claim 9, wherein the panel receiving surface is one of a wall, a floor and a ceiling.

11. The panel of claim 1, wherein the panel is part of a shower.

12. The panel of claim 1, wherein the panel is part of a bathtub.

13. A method for manufacturing a panel, comprising:
providing a panel mold having a base panel;
applying a layer of acrylic modified isophthalic gelcoat on the base panel of the panel mold;
applying an intermediary layer on the layer of acrylic modified isophthalic gelcoat; and
applying a layer of polyester resin on the intermediary layer.

14. The method of claim 13, wherein said applying a layer of acrylic modified isophthalic gelcoat comprises applying a layer of AcrylX™ on the base panel of the panel mold.

15. The method of claim 13, wherein said applying a layer of acrylic modified isophthalic gelcoat comprises spraying the acrylic modified isophthalic gelcoat on the base panel of the panel mold.

16. The method of claim 14, wherein said spraying the layer of acrylic modified isophthalic gelcoat comprises spraying the AcrylX™ on the base panel of the panel mold.

17. The method of claim 13, wherein said applying an intermediary layer comprises applying an intermediary layer of at least one of a polymer, a fiber-reinforced polymer, a polyester and a resin.

18. The method of claim 13, wherein said applying an intermediary layer comprises spraying the intermediary layer.

19. The method of claim 13, further comprising applying an additional layer on the layer of polyester resin.

20. The method of claim 19, wherein said applying an additional layer comprises applying the additional layer of at least one of a polymer, a fiber-reinforced polymer, a polyester and a resin.

21. The method of claim 19, wherein said applying an additional layer comprises spraying the additional layer.

22. The method of claim 13, wherein said applying a layer of polyester resin comprises applying a layer of ArmorCore™.

23. The method of claim 13, wherein said applying a layer of polyester resin comprises spraying the polyester resin on the intermediary layer.
